(19) United States
(12) Patent Application Publication
(10) Pub. No.: US 2026/0014707 A1
(43) Pub. Date: Jan. 15, 2026

(54) ROBOT CONTROL DEVICE, ROBOT SYSTEM, AND ROBOT CONTROL PROGRAM

(71) Applicant: Fanuc Corporation, Minamitsuru-gun, Yamanashi (JP)

(72) Inventors: Yuuki TAKAHASHI, Minamitsuru-gun, Yamanashi (JP); Wataru TOOYAMA, Minamitsuru-gun, Yamanashi (JP)

(73) Assignee: Fanuc Corporation, Minamitsuru-gun, Yamanashi (JP)

(21) Appl. No.: 18/993,714

(22) PCT Filed: Nov. 15, 2022
(86) PCT No.: PCT/JP2022/042409

§ 371 Date: Jan. 13, 2025

(51) Int. Cl. B25J 9/16; B25J 19/02

(52) U.S. Cl. CPC B25J 9/1697; B25J 9/1612; B25J 9/1666; B25J 19/023

(57) ABSTRACT

This robot control device controls a robot having a hand so that the robot withdraws objects from a randomly stacked pile, and includes a withdrawal position calculating unit, a spatial information storage unit, a shape storage unit, and a motion path generating unit. The withdrawal position calculating unit calculates a withdrawal position of an object to be withdrawn by the robot on the basis of image information from an image capturing device which captures an image including the objects, and the spatial information storage unit stores a movable range in which the robot can operate and an interference range in which the robot interferes with the surroundings in the movable range. The shape storage unit stores the shapes of the robot and the hand, and the motion path generating unit generates a motion path of the hand on the basis of outputs of the withdrawal position calculating unit, the spatial information storage unit, and the shape storage unit such that the robot does not interfere with the surroundings. The shape storage unit stores a pre-gripping hand shape before the hand grips the object and a post-gripping hand shape after the hand grips the object.

### CROSS REFERENCE TO RELATED APPLICATIONS

This is the U.S. National Phase application of PCT/JP2022/042409, filed Nov. 15, 2022, the disclosure of this application being incorporated herein by reference in its entirety for all purposes.

### FIELD OF THE INVENTION

The present disclosure relates to a robot controller, a robot system, and a robot control program.

### BACKGROUND OF THE INVENTION

In recent years, a robot has been used in various industries to grip and take out an object (workpiece). One of the applications of such a robot is for taking out individual workpieces from among multiple workpieces randomly placed inside a housing vessel (container), so-called “Bin picking” applications.

In Bin picking applications, for example, positions and postures of a plurality of workpieces in the container are detected based on image information by an image capturing device such as a stereo camera, and the workpiece may be taken out using a hand of the robot.

For example, to take out a workpiece stacked in the container by the robot, a posture of the hand for gripping the workpiece is taught in a position relative to a posture of the workpiece. Further, the hand approaches to the taught position relative to the workpiece captured by the image capturing device, so that the workpiece is gripped and taken out.

At this time, with respect to a route in which the hand approaches the workpiece, for example, information on devices placed around the robot and information on the hand may be registered in advance in order to generate a route that does not interfere with peripheral devices and the like.

Specifically, the robot controller for controlling the robot is provided with a storage unit that stores a movable range of the robot and an interference region in which the hand (robot) interferes with the peripheral devices, containers, and the like in the movable range of the robot.

Further, the robot controller is also provided with a processing unit that calculates a take-out position of the workpiece to be taken out by the hand and generates an operation route of the hand, based on image information from the image capturing device.

Conventionally, various techniques have been proposed for taking out stacked workpieces without interfering with peripheral devices and the like by a hand of a robot, based on image information from an image capturing device.

### Patent Literature

[PTL 1] Japanese Unexamined Patent Publication (Kokai) No. 2022-017739

[PTL 2] Japanese Unexamined Patent Publication (Kokai) No. 2022-017738

### SUMMARY OF THE INVENTION

As described above, for example, to take out the workpiece stacked in the container by the robot, a posture of the hand for gripping the workpiece is taught in a position relative to a posture of the workpiece. Further, the hand approaches the taught position relative to the workpiece captured by the image capturing device, so that the workpiece is gripped and taken out.

Incidentally, a shape before gripping the workpiece by the hand of the robot is often different from a shape after gripping the workpiece by the hand. However, in the case of taking out the workpiece bulk-loaded by the robot, the operation route is usually generated in the shape when the workpiece is not gripped, without considering the shape before and after gripping the workpiece by the hand.

Therefore, when the hand shape assumed to generate the operation route is too small with respect to the hand shape after gripping, the hand may come into contact with the container, the peripheral device, and the like. For example, when the shape of the hand changes during the operation to grip the workpiece and becomes larger than the expected hand shape, the workpiece or hand may contact an edge of the container or surrounding equipment and the like, with the result that a breakage or damage may occur.

On the other hand, when the hand shape assumed to generate the operation route is too large with respect to the hand shape after gripping, the route will be longer than necessary, and thus the processing time may increase, and work efficiency be reduced. Specifically, when the shape of the hand changes in the middle of the workpiece and becomes smaller than the assumed hand shape, since the hand moves along an unnecessary route, the processing time may increase, and the workpiece efficiency may decrease. Further, when the assumed hand shape is too large, there is a risk that it will not be possible to find a route that allows the workpiece to be taken out without interference.

Therefore, it is desired to provide a robot controller, a robot system, and a robot control program with which it is possible to generate an efficient operation route without causing contact and the like through the front and rear of gripping of a workpiece (object) by a hand.

According to an embodiment of the present invention, there is provided a robot controller for controlling a robot to take out a bulk-loaded object by a robot including a hand, containing a take-out position calculation unit, a spatial information storage unit, a shape storage unit, and an operation route generation unit.

The take-out position calculation unit is configured to calculate a take-out position of an object to be captured by the robot based on image information from an image capturing device that captures an image including the object, and the spatial information storage unit is configured to store a movable range in which the robot is movable and an interference range in which the robot interferes with surroundings in the movable range.

The shape storage unit is configured to store a shape of the robot and the hand, and the operation route generation unit is configured to generate an operation route of the hand so as not to interface the robot with the surroundings, based on outputs of the take-out position calculation unit, the spatial information storage unit and the shape storage unit. The shape storage unit stores a pre-gripping hand shape before the hand grips the object, and a post-gripping hand shape after the hand grips the object.

The objects and effects of the present invention will be recognized and obtained by using the components and combinations specified in the claims. Both the general description as above and the detailed description below are exemplary and descriptive, and do not limit the invention described in the claims.

### BRIEF DESCRIPTION OF DRAWINGS

FIG. 1 is a diagram schematically depicting an example of a robot system.

FIG. 2 is a diagram for explaining the problem in the robot system depicted in FIG. 1.

FIG. 3 is a functional block diagram depicting a main part configuration in one embodiment of the robot controller according to the present embodiment.

FIG. 4 is a diagram for explaining an example of processing in one embodiment of the robot system according to the present embodiment.

FIG. 5 is a diagram (part 1) for explaining an example of an interference avoidance route generation method applied to the robot system according to the present embodiment.

FIG. 6 is a diagram (part 2) for explaining an example of an interference avoidance route generation method applied to the robot system according to the present embodiment.

FIG. 7 is a functional block diagram depicting a main part configuration in a modification example of the robot controller according to the present embodiment.

FIG. 8 is a diagram for explaining an example of processing in a modification example of the robot system according to the present embodiment.

FIG. 9 is a diagram for explaining an example of a workpiece handled by the robot system according to the present embodiment.

FIG. 10 is a flowchart for explaining an example of processing in one embodiment of the robot control program according to the present embodiment.

### DETAILED DESCRIPTION OF EMBODIMENTS OF THE INVENTION

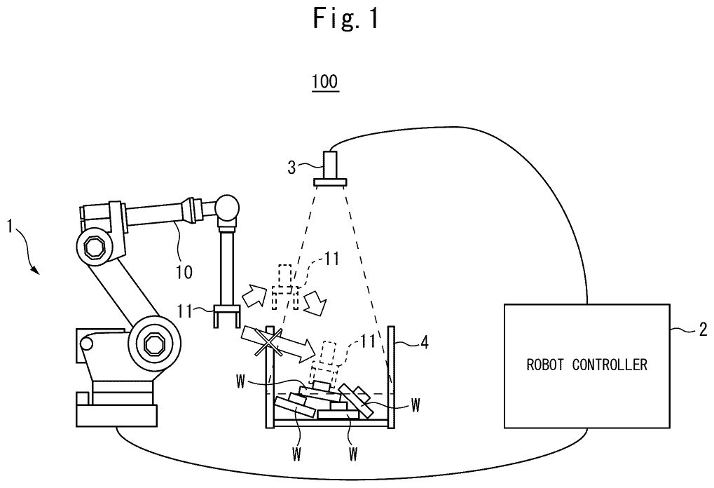

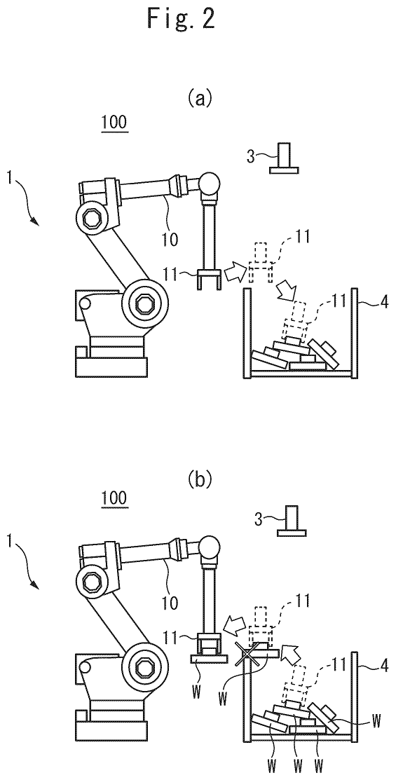

First, an example of a robot system and its problem will be described with reference to FIG. 1 and FIG. 2, before a robot controller, a robot system, and a robot control program according to the present embodiment will be described in detail.

FIG. 1 is a diagram schematically depicting an example of a robot system, and depicting an example of a robot system used for so-called “Bin picking” applications. In FIG. 1, a reference 100 denotes a robot system, 1 denotes a robot, 2 denotes a robot controller, 3 denotes an image capturing device, 4 denotes a container, and W denotes a workpiece.

As depicted in FIG. 1, the robot system 100 includes the robot 1, the robot controller 2, and the image capturing device 3. A hand 11 is provided at a tip of an arm 10 of the robot 1. Further, for example, an individual workpiece W may be gripped and taken out from a plurality of workpieces W randomly placed in the container 4 by the hand 11.

It should be noted that, in FIG. 1, the hand 11 is configured to grip the workpiece W by gripping the workpiece W, but the hand 11 is not limited to gripping the workpiece W with claws, and may, for example, adsorb and grip the workpiece W by negative pressure. The robot 1 is not limited to, for example, an industrial robot used in a factory and the like, but may be a robot used in various places.

The robot controller 2 includes a processing unit (21: arithmetic processing unit) and a storage unit (24), and the processing unit controls the robot 1 based on a program (software program) and the like installed in advance in the storage unit. The storage unit also stores, for example, a shape of a hand or a workpiece, a movable range of the robot 1 (hand 11), an interference region, and the like.

It should be noted that, it is also possible to connect a teach pendant to the robot controller 2 so as to perform teaching and the like of the robot 1. Further, so as to assist or replace the processing of the image or the operation route by the processing unit, it is also possible to add an external computer having excellent processing capability to the robot controller 2.

The image capturing device 3 is provided above the container 4 and captures images of a plurality of workpieces W in the container 4 or a hand 11 of the robot 1 with the workpiece W. In this case, image information captured by the image capturing device 3 is input to the robot control deice 2. The image capturing device 3 may be provided above the container 4, for example, not limited to being provided on the ceiling, and may be provided in the vicinity of the hand 11 and the like.

The image capturing device 3 may capture a three-dimensional image using a plurality of cameras, such as a stereo camera, but may be, for example, a TOF (Time Of Flight) type image sensor. Further, the image capturing device 3 may be variously changed or modified in accordance with a type of the robot 1 to be used, a required processing, and the like.

It should be noted that, FIG. 1 depicts a state in which, when a predetermined workpiece W is gripped by the hand 11 and the hand 11 is moved at the shortest distance, the hand 11 is in contact with a wall of the container 4. At this time, for example, the robot controller 2 may generate the operation route of the robot 1 based on the image information captured by the image capturing device 3 and the movable range, interference region, and the like of the robot 1 stored in the storage unit.

Specifically, the robot controller 2 sets an avoidance point above the wall of the container 4, for example, and generates an operation route so that the hand 11 passes through the avoidance point. This makes it possible to approach and grip the workpiece W without bringing the hand 11 into contact with the wall of the container 4.

FIG. 2 is a diagram for explaining the problem in the robot system depicted in FIG. 1, and for explaining a generation of an operation route of a hand 11 (robot 1). In this case, FIG. 2(a) is intended to describe before griping (grasping) a workpiece W by the hand 11, and FIG. 2(b) is intended to describe after griping (grasping) the workpiece W by the hand 11.

As depicted in FIG. 2(a), when the workpiece W is gripped by the hand 11, for example, based on image information captured by an image capturing device 3 and the like, the hand 11 approaches a posture of the workpiece W so as to be a relative position taught by the hand 11. In this case, since the shape of the hand 11 is before gripping the workpiece W, for example, if the shape of the hand 11 is stored in the storage unit in advance, the operation route of the hand 11 may be generated based on the shape of the hand 11.

Specifically, based on the shape of only the hand 11, while avoiding a wall of the container 4, the hand 11 approaches the posture of the workpiece W so as to be a relative position taught by the hand 11, and the workpiece W is gripped by the hand 11. At this time, since the shape of the hand 11 is not changed and is constant, for example, the hand 11 does not come into contact with the wall of the container 4.

On the other hand, as depicted in FIG. 2(b), when the hand 11 gripping the workpiece W is moved by the operation route based on the shape of the hand 11, for example, the workpiece W may be in contact with the wall of the container 4. Specifically, since a shape of the hand 11 gripping the workpiece W is changed to be larger than a shape of only the hand 11, for example, even if the hand 11 itself does not contact, the hand 11 gripping the workpiece W may become into contact with the wall of the container 4.

This may not occur only when the shape after gripping the workpiece W by the hand 11 is larger than the shape before gripping the workpiece W, but may cause the same problem when the shape changes before and after gripping the workpiece W by the hand 11.

Specifically, when the hand shape assumed to generate the operation route is too small to the hand shape after gripping, the hand 11 (robot 1) or the workpiece W is in contact with the container 4, the peripheral device, and the like. For example, when the shape of the hand changes in the middle of the workpiece and becomes larger than the assumed hand shape, the workpiece or hand may become into contact with an edge of the container or surrounding equipment and the like, so that a breakage or damage may occur.

On the other hand, when the hand shape assumed to generate the operation route is too large with respect to the hand shape after gripping, the route will be longer than necessary, so that a processing time may increase, and a work efficiency may reduce. For example, when the shape of the hand changes in the middle of the workpiece and becomes smaller than the assumed hand shape, since the hand moves the unnecessary route, the processing time may increase, and the workpiece efficiency may decrease. Further, when the assumed hand shape is too large, there is a risk that it will not be possible to find a route that allows the workpiece to be taken out without interference.

Hereinafter, examples of a robot controller, a robot system, and a robot control program according to the present embodiment will be described in detail with reference to the accompanying drawings. In each of the drawings, the same or similar constituent elements are assigned the same or similar reference signs. Furthermore, the embodiments described below do not limit the technical scope and meaning of the terms of the invention set forth in the claims.

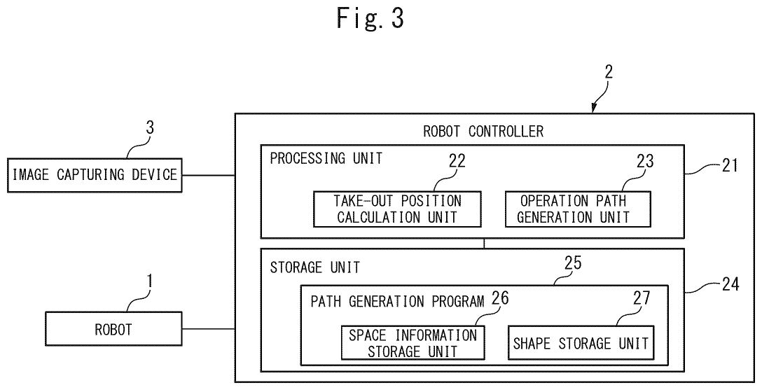

FIG. 3 is a functional block diagram depicting a main part configuration in one embodiment of the robot controller according to the present embodiment. As depicted in FIG. 3, the robot controller 2 according to the present embodiment controls the robot 1 including the hand 11 to take out the workpiece W stacked in the container 4, and includes a processing unit 21 and a storage unit 24. In this case, the robot 1 and the image capturing device 3 are substantially the same as those described with reference to FIG. 1, and therefore, the detailed description thereof will be omitted.

The processing unit (arithmetic processing unit) 21 includes a take-out position calculation unit 22 and an operation route generation unit 23, and the storage unit 24 includes a route generation program 25. The route generation program 25 includes a spatial information storage unit 26 and a shape storage unit 27.

The take-out position calculation unit 22 calculates a take-out position of the workpiece W taken out by the robot 1 based on image information from the image capturing device 3 that captures an image including the workpiece W. Specifically, the take-out position calculation unit 22 detects the workpiece W from the image captured by the image capturing device 3 to specify a position thereof, and calculates the take-out position of the workpiece W that may be taken out by the hand 11 of the robot 1. It should be noted that the image capturing device 3 may capture an image including the workpiece W and the hand 11.

The spatial information storage unit 26 stores a movable range in which the robot 1 may operate, and an interference region (X) in which the robot 1 interferes with surroundings in the movable range. In this case, for example, when generating an operation route of the robot 1 (hand 11), the interference region is information relating to a spatial region such as an obstacle that does not interfere with each part of the robot 1.

The shape storage unit 27 stores a shape of the robot 1 and the hand 11. In this case, the shape storage unit 27 stores both a pre-gripping hand shape before the hand 11 grips the workpiece W and a post-gripping hand shape after the hand 11 grips the workpiece W. Further, the shape storage unit 27 may also store information such as a shape of a plurality of different types of workpieces W, a front-rear hand shape for gripping each workpiece W (shape and packaging style of each workpiece), and weight information and the like associated with each workpiece W.

The route generation program 25 is executed by the processing unit 21, and is a program for generating an operation route of the hand 11 based on image information from the image capturing device 3 and outputs of the spatial information storage unit 26 and the shape storage unit 27. It should be noted that, for example, when the capability of the processing unit 21 of the robot controller 2 is insufficient, an external computer including excellent processing capability may be added, and thereby image processing, processing of the route generation program 25, and the like may be executed.

The operation route generation unit 23 generates an operation route of the hand 11 (robot 1) based on outputs of the take-out position calculation unit 22, the spatial information storage unit 26 and the shape storage unit 27, and the image information from the image capturing device 3.

It should be noted that the operation route generation unit 23 generates the pre-gripping route from a predetermined start position (first position) of the hand 11 to the take-out position of the workpiece W based on the pre-gripping hand shape (packaging style of the pre-gripping hand shape). Further, the operation route generation unit 23 generates a post-gripping route from the take-out position of the workpiece W to a predetermined end position (second position) of the hand 11 based on the post-gripping hand shape (packaging style of the post-gripping hand shape).

For example, when the robot system is configured to take out a plurality of types of workpieces W, the shape storage unit 27 outputs a post-gripping hand shape corresponding to the type of a specified workpiece W to the operation route generation unit 23. Further, the operation route generation unit 23 generates a post-gripping route of the hand 11 based on the post-gripping hand shape output from the shape storage unit 27.

It should be noted that, if the hand 11 is attached to an arm (movable portion) 10 that may be operable with respect to the robot 1, the operation route generation unit 23 may modify the post-gripping route of the arm 11 based on an operation of the hand 11 with respect to the robot 1. Specifically, the operation route generation unit 23 may correct the pre-gripping hand shape and the post-gripping hand shape stored in the shape storage unit 27 based on the operation of the hand 11 with respect to the robot 1, and may generate an operation route of the hand 11.

For example, a three-dimensional image capturing device using a plurality of cameras or a TOF type image sensor may be applied as the image capturing device 3, and further a two-dimensional image capturing device may be applied as the image capturing device 3 depending on specifications thereof. As described above, according to the robot controller according to the present embodiment, it is possible to generate an efficient operation route without causing contact and the like through the hand before and after gripping the workpiece.

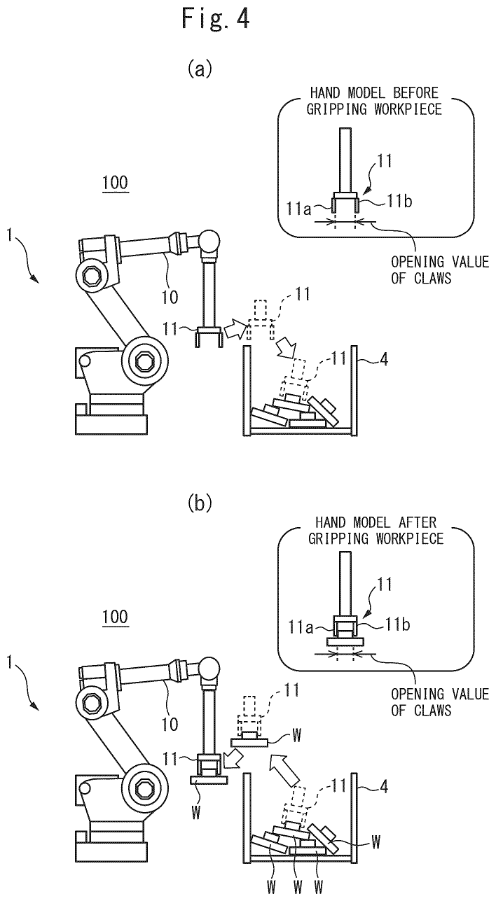

FIG. 4 is a diagram for explaining an example of processing in one embodiment of the robot system according to the present embodiment, and is for explaining processing in a system to which the robot controller of FIG. 3 is applied. It should be noted that FIG. 4(a) is intended to describe before griping a workpiece W by the hand 11, and FIG. 4(b) is intended to describe after griping the workpiece W by the hand 11. In this case, FIG. 4(a) and FIG. 4(b) correspond to FIG. 2(a) and FIG. 2(b) described above, and FIG. 4(a) substantially depicts the same configurations of FIG. 2(a), except for a hand model before gripping the workpiece (pre-gripping hand shape).

As depicted in FIG. 4(a), when a workpiece W is gripped by the hand 11, for example, based on image information captured by the image capturing device 3 and the like, the hand 11 approaches a posture of the workpiece W so as to be a relative position taught by the hand 11. In this case, since the shape of the hand 11 is before gripping the workpiece W, for example, if the shape of the hand 11 is stored in the storage unit in advance, the operation route of the hand 11 may be generated based on the shape (the pre-gripping hand shape) of the hand 11.

Specifically, the operation route generation unit 23 generates a pre-gripping route from the start position (first position) of the predetermined hand 11 to the take-out position of the workpiece W based on the pre-gripping hand shape (packaging style of the pre-gripping hand shape). At this time, since the shape of the hand 11 is not changed from the start position to the take-out position of the workpiece W, the hand 11 does not come into contact with the wall and the like of the container 4.

On the other hand, as depicted in FIG. 4(b), when the hand 11 gripping the workpiece W is moved, the shape of the hand 11 changes significantly from the shape of the hand 11 itself by gripping the workpiece W. In this case, according to the robot system of the present embodiment, the shape (post-gripping hand shape) of the hand 11 gripping the workpiece W is stored in the shape storage unit 27 together with the pre-gripping hand shape.

Specifically, the operation route generation unit 23 generates the post-gripping route from the take-out position to the end position of the workpiece W based on the post-gripping hand shape (packaging style of the post-gripping hand shape). Therefore, for example, even when the post-gripping hand shape changes to larger than the pre-gripping hand shape, the hand 11 (workpiece W) may generate a post-gripping route without contacting the wall and the like of the container 4.

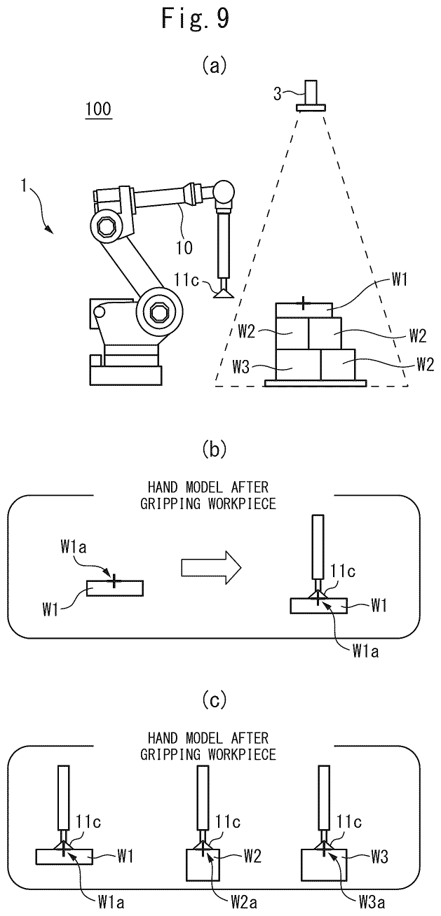

It should be noted that, whether or not the hand 11 grips the workpiece W may be recognized, for example, from a distance between claws 11a and 11b of the hand 11 (opening of the claws) as is clear from the comparison of FIG. 4(a) and FIG. 4(b). In addition, for example, in the case of an adsorption type hand 11c using a negative pressure as described later with reference to FIG. 9, whether or not the workpiece W is gripped may be recognized, for example, from a change in pressure (negative pressure) or a change in weight by the hand 11c. As a result, it is possible to specify whether the hand 11 is moved based on the pre-gripping route or the post-gripping route.

In this case, the robot system according to the present embodiment may not be applied only when the post-gripping hand shape changes to larger than the pre-gripping hand shape, but also when the post-gripping hand shape changes to smaller than the pre-gripping hand shape. Specifically, when the post-gripping hand shape changes to smaller than the pre-gripping hand shape, the operation route generation unit 23 may reduce an unnecessary route to generate the post-gripping route based on the small-changed post-gripping hand shape.

The above processing may perform simulation by executing the route generation program 25 of the storage unit 24 by the processing unit 21 to generate a route, and to operate the robot 1 based on the route. As described above, according to the robot controller of the present embodiment, it is possible to generate an efficient operation route without causing contact and the like before and after gripping the workpiece by the hand.

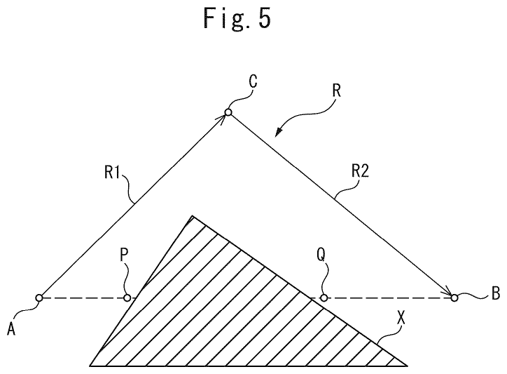

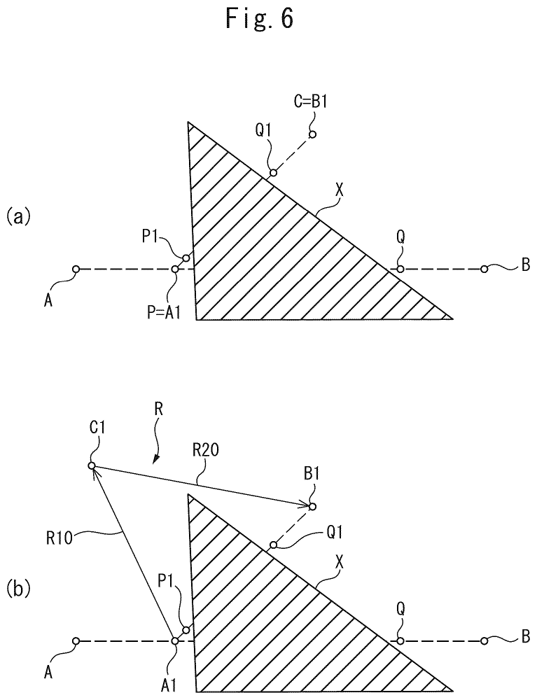

FIG. 5 and FIG. 6 are diagrams for explaining an example of an interference avoidance route generation method applied to the robot system according to the present embodiment, and wherein an interference region X is provided on an operation route of a hand (robot). In FIG. 5 and FIG. 6, a reference A denotes a start position of the operation route of the hand 11, B denotes an end position of the operation route of the hand 11, C denotes an avoidance point (provisional avoidance point), and X denotes the interference region.

As depicted in FIG. 5, for example, when the hand 11 is moved from the start position A to the end position B of the operation route, the hand 11 is collided with the interference region X when the hand 11 is moved directly from A to B. Therefore, the operation route of the hand 11 is changed so as to pass through the avoidance point C in a middle of moving from A to B, and an operation route R, in which the hand 11 does not collide with the interference region X is generated.

In other words, when the hand 11 is moved from the start position A to the end position B of the operation route, the provisional avoidance point C is obtained between an immediately preceding position P and an immediately after position Q where a straight line connecting A and B intersects the interference region X. This provisional avoidance point C is preferably obtained on two division lines of the immediately preceding position P and the immediately after position Q, or in the vicinity of the two division lines.

Next, it is determined whether or not the interference region X is present on a straight line connecting the start position A and the provisional avoidance point C, and if there is no interference region X, a route R1 connecting the start position A and the provisional avoidance point C is once established.

If the interference region X is present on the straight line connecting the start position A and the provisional avoidance point C, it is determined whether or not the interference region X is present on a straight line connecting the immediately preceding position P and the provisional avoidance point C. In this case, if there is no interference region X on the straight line connecting the immediately preceding position P and the provisional avoidance point C, the route R (A→P→C) connecting the provisional avoidance point C from the start position A via the immediately preceding position P is once established. On the other hand, if the interference region X is present on the straight line connecting the immediately preceding position P and the provisional avoidance point C, for example, the processing described with reference to FIG. 6 is performed.

Further, it is determined whether or not the interference region X is present on a straight line connecting the provisional avoidance point C and the end position B, and if there is no interference region X, a route R2 connecting the provisional avoidance point C and the end position B is established. In other words, the provisional avoidance point C is set as an avoidance point C, and the once established routes R1 and R2 are actually established as the operation route of the hand 11.

As a result, the routes R1 and R2 connecting the start position A, the avoidance point C, and the end position B are established, so that an interference avoidance route R may be generated. It should be noted that when the interference region X is present on the straight line connecting the provisional avoidance point C and the end position B, the route may be determined similarly to the case where the interference region X is present on the straight line connecting the start position A and the provisional avoidance point C described above. Next, a case where the interference region X is present on the straight line connecting the immediately preceding position P and the provisional avoidance point C will be described with reference to FIG. 6.

FIG. 6(a) and FIG. 6(b) depict the case where an interference is present on an operation route between an immediately preceding position P1 of the interference region X and a provisional avoidance point C, and are used to explain a generation process for generating an interference avoidance route at that time. As depicted in FIG. 6(a), when the interference region X is present on a straight line connecting the immediately preceding position P and the provisional avoidance point C, the immediately preceding position P is regarded as a start position A1, and the provisional avoidance point C is regarded as an end position B1 so as to re-determine a provisional avoidance point C1.

Specifically, as depicted in FIG. 6(b), since the interference region X is present on a straight line connecting the start position A1 (P) to the end position B1 (C), for example, the provisional avoidance point C1 is determined on the two division lines of the immediately preceding position P1 and the immediately after position Q1.

In other words, it is determined whether or not the interference region X is present on the straight line connecting the start position A1 and the provisional avoidance point C1, and if there is no interference region X, a route R10 connecting the start position A1 and the provisional avoidance point C1 is once established. In the example depicted in FIG. 6(a) and FIG. 6(b), since the interference region X is not present on the straight line connecting the start position A1 and the provisional avoidance point C1, the route R10 is established. Further, since there is no interference region X on a straight line connecting the provisional avoidance point C1 and the end position B1, a route R20 is established.

As a result, for example, the route from the original start position A to the provisional avoidance point C (B1) may be established as A→P (A1)→C1→C (B1), that is, R10→R20 may be established. In this case, when the interference region X is present on the straight line connecting the provisional avoidance point C1 and the end position B1, similar processing may be repeated, and an operation route (interference avoidance route R) may be generated without passing through the interference region X.

It should be noted that the interference avoidance route generation method described with reference to FIG. 5 and FIG. 6 is merely an example, and various interference avoidance route generation methods may be applied to the robot system according to the present embodiment.

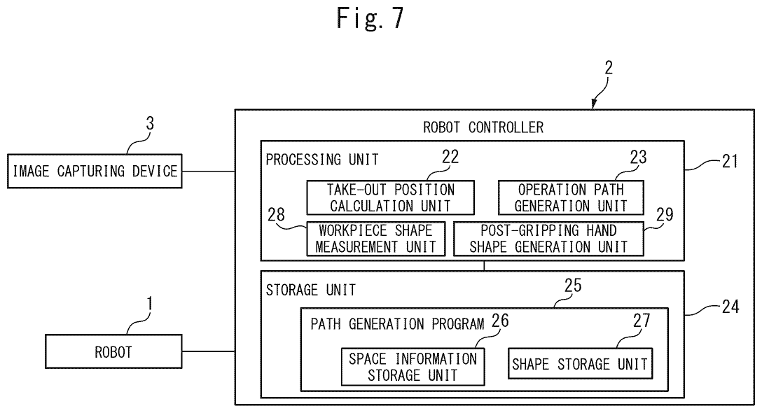

FIG. 7 is a functional block diagram depicting a main part configuration in a modification example of the robot controller according to the present embodiment. As is clear from the comparison of FIG. 7 and FIG. 3, in the robot controller 2 according to the present modification, the processing unit 21 includes a workpiece shape measurement unit 28 and a post-gripping hand shape generation unit 29 together with the take-out position calculation unit 22 and the operation route generation unit 23.

The workpiece shape measurement unit (object shape measurement unit) 28 measures a shape of the workpiece W based on image information from an image capturing device 3. In this case, the shape of the workpiece W used for the processing of the processing unit 21 may apply the shape of the workpiece W measured by the workpiece shape measurement unit 28, but the shape of the workpiece W stored in a shape storage unit 27 may be referenced to apply the workpiece W.

The post-gripping hand shape generation unit 29 generates a post-gripping hand shape (post-gripping packaging style) based on the workpiece shape measured by the workpiece shape measurement unit 28. In this case, the post-gripping hand shape generation unit 29 may determine, for example, a specific type of workpiece in the plurality of workpieces based on an output of a weight sensor provided in the hand 11, and output a post-gripping hand shape corresponding to the workpiece.

The image capturing device 3 may be configured as, for example, a three-dimensional image capturing device that does not generate a blind spot by a plurality of high-precision cameras. In this case, the post-gripping hand shape generation unit 29 generates a post-gripping hand shape based on the image information mainly from the three-dimensional image capturing device 3, for example, in accordance with an operation by a robot system 100 or a workpiece W handled by the robot system 100. It should be noted that even if the post-grip hand shape generation unit 29 may directly generate a post-grip hand shape from the image information, it is preferable to generate the post-grip hand shape by referring to multiple post-grip hand shapes previously stored in the shape storage unit 27.

As described above, the shape storage unit 27 may also store information such as shapes of a plurality of different types of workpieces W, hand shapes before and after gripping each workpiece W, and a weight associated with each workpiece W. In this case, the post-gripping hand shape generation unit 29 may determine the type of the workpiece based on both the workpiece shape measured by the workpiece shape measurement unit 28 and the weight of the workpiece measured by the weight sensor.

The operation route generation unit 23 generates an operation route of the hand 11 based on the output of the post-gripping hand shape generation unit 29 such that the robot 1 does not interfere with the surroundings. In this case, as described with reference to FIG. 3, the operation route generation unit 23 generates a pre-gripping route from the start position of the predetermined hand 11 to the take-out position of the workpiece W based on the pre-gripping hand shape. Further, the operation route generation unit 23 generates a post-gripping route from the take-out position of the workpiece W to the end position of the predetermined hand 11 based on the post-gripping hand shape.

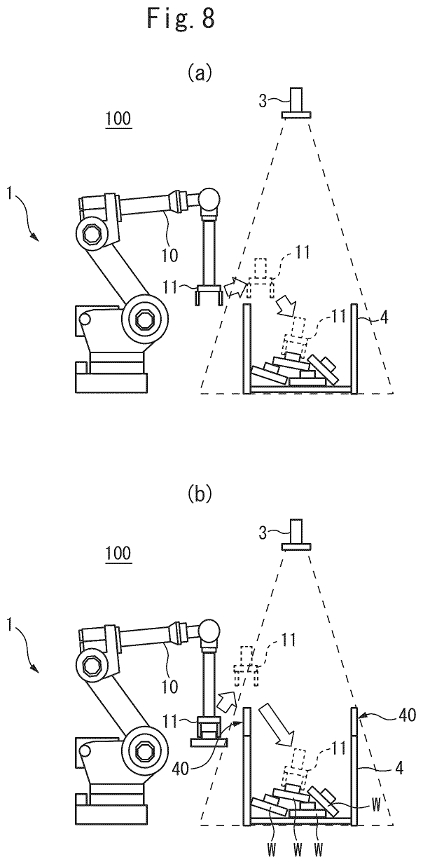

FIG. 8 is a diagram for explaining an example of processing in a modification example of the robot system according to the present embodiment. In this case, an image capturing device 3 is configured as, for example, a high-accuracy three-dimensional image capturing device that does not generate a blind spot by a plurality of high-precision cameras. Further, a container 4 in which the plurality of workpieces W are randomly placed is replaced with another container 4 in this order when the taking-out process by the robot 1 (hand 11) is completed.

As described above, for example, when a plurality of containers 4 are replaced so as to take out workpieces W, the shape and arrangement location of the container 4 may be different depending on the respective solids. In such a case, for example, the operation route generation unit 23 may grip changes in the shape and arrangement position of the container 4 based on the image information from the image capturing device 3 to generate the operation route of the hand 11.

It should be noted that the image capturing device 3 is not limited to a high-precision three-dimensional image capturing device having no blind spot, and may be selected as a preferable image capturing device based on an accuracy and content of an operation required for the robot system 100. In any case, according to the modification of the robot system 100 according to the present embodiment, it is possible to generate an efficient operation route without causing contact and the like through the hand 11 before and after gripping the workpiece W.

FIG. 9 is a diagram for explaining an example of a workpiece handled by the robot system according to the present embodiment, and for depicting a case where the robot system 100 handles three types of workpieces W1, W2 and W3 having different shapes. In this case, FIG. 9(a) depicts an overall configuration of the robot system, FIG. 9(b) depicts a hand model after gripping the workpiece, and FIG. 9(c) depicts a hand model after gripping the workpiece corresponding to the three types of workpieces.

As depicted in FIG. 9(a), the robot system 100 performs an operation for taking out three types of workpieces W1, W2 and W3 having different shapes. The hand 11c of the robot 1 is configured to suck and take out the workpiece W by negative pressure instead of gripping (taking out) the workpiece W by the claw.

As depicted in FIG. 9(b), when the workpiece W1 is gripped by the hand (adsorption type) 11c, for example, the take-out position calculation unit 22 calculates a take-out position W1a of the workpiece W based on the image information from the image capturing device 3. In this case, the take-out position W1a is set, for example, at a center position of an upper surface of the workpiece W. Then, the robot controller 2 controls the robot 1 to move the hand 11c provided at the tip of the arm 10 to the take-out position W1a to grip (adsorb) the workpiece W.

As depicted in FIG. 9(c), take-out positions W1a, W2a and W3a of the three types of workpieces W1, W2 and W3 are set at center positions of upper surfaces of the respective workpieces W1, W2 and W3. Further, the robot controller 2 controls the robot 1 to move and grip the workpiece W1, W2 and W3 taken out by the hand 11c to the take-out positions W1a, W2a and W3a.

In this case, the shape storage unit 27 stores in advance, for example, hand shapes before and after gripping a plurality of types of workpieces W1, W2 and W3 having different shapes by the hand 11c (pre-gripping hand shape and post-gripping hand shape).

As described above, for example, when handling three types of workpieces W1, W2 and W3 having different shapes, the take-out position calculation unit 22 specifies types of workpieces W1, W2 and W3 based on the image captured by the image capturing device 3. Further, the take-out position calculation unit 22 calculates take-out positions W1a, W2a and W3a of the specified types of the workpieces.

The shape storage unit 27 outputs a pre-gripping hand shape and a post-gripping hand shape corresponding to each of the specified types of the workpieces. Further, the operation route generation unit 23 generates an operation route of the hand 11c based on the pre-gripping hand shape and the post-gripping hand shape output from the shape storage unit 27.

It should be noted that, for example, the shape storage unit 27 may store information of shapes of the plurality of types of workpieces W1, W2 and W3, and/or information of weights of the plurality of types of workpieces W1, W2 and W3. In this case, the post-gripping hand shape generation unit 29 may also specify a type of the workpiece W based on, for example, the workpiece shape measured by the workpiece shape measurement unit 28.

Further, the post-gripping hand shape generation unit 29 may recognize a weight of the workpiece by, for example, a weight sensor (not shown) provided in the hand 11c, and may specify the workpiece W gripped based on the measured weight. In addition, it is also possible to specify the type of the gripped workpiece W based on both the shape and weight of the workpiece. In addition, for example, the hand is a claw-shaped hand 11 as described with reference to FIG. 4, and when the opening of the claw gripping the plurality of types of workpieces is different, the type of the workpiece may be specified from the opening of each claw.

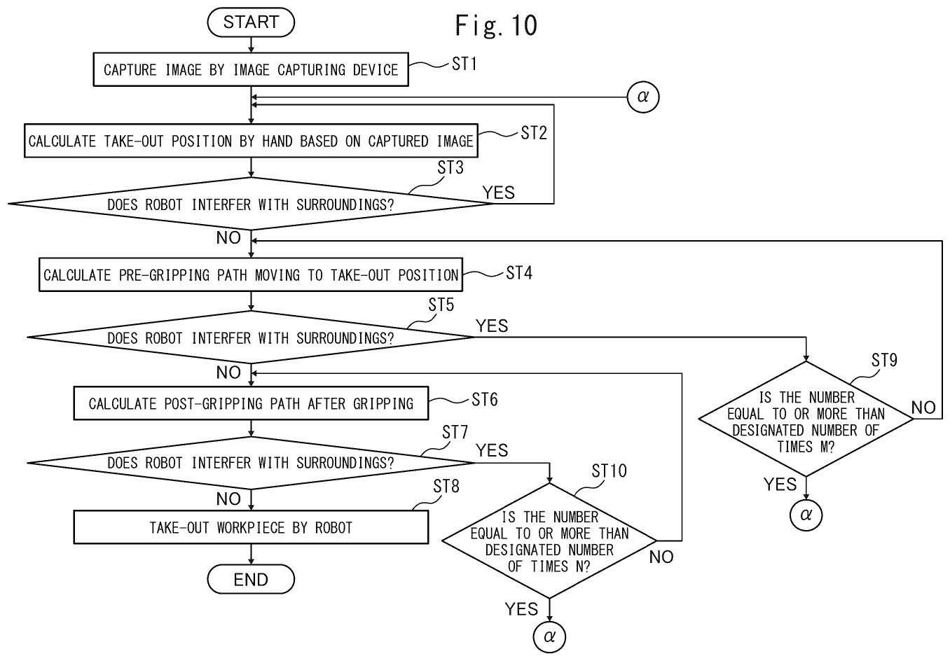

FIG. 10 is a flowchart for explaining an example of processing in one embodiment of the robot control program according to the present embodiment. The robot control program (route generation program 25) is stored in the storage unit 24 of the robot controller 2 depicted in FIG. 3, for example, and is executed by the processing unit (arithmetic processing unit) 21. The robot control program is, for example, a program that simulates and generates a post-gripping route from a first position to a take-out position of the workpiece and a post-gripping route from a take-out position of the workpiece to a second position.

As depicted in FIG. 10, when an example of processing in one embodiment of the robot control program according to the present embodiment is started (START), the image capturing device 3 captures an image in step ST1. Further, in step ST2, the gripping position by the hand 11 of the robot 1 is calculated from the captured image by the image capturing device 3.

Further, in step ST3, it is determined whether the robot 1 (hand 11) interferes with peripheral equipment and the like. In this case, the determination as to whether the robot 1 interferes with the peripheral device and the like in step ST3 is performed, for example, based on image information from the image capturing device 3, output of the spatial information storage unit 26 and the shape storage unit 27, and the like.

In step ST3, when it is determined that the robot 1 interferes with the peripheral device and the like (YES), the process returns to step ST2, and the gripping position by the hand 11 is calculated again from the captured image. On the other hand, in step ST3, when it is determined that the robot 1 does not interfere with the peripheral device and the like (NO), the process proceeds to step ST4, and calculates (generates) the pre-gripping route until reaching the gripping position.

In other words, in step ST4, the pre-gripping route from the predetermined first position to the take-out position of the workpiece W is generated based on the hand shape (pre-gripping hand shape) before gripping the workpiece W. Specifically, the operation route generation unit 23 generates a pre-gripping route based on the output of the take-out position calculation unit 22 and the spatial information storage unit 26, the pre-gripping hand shape from the shape storage unit 27, and the image information from the image capturing device 3.

Next, the process proceeds to step ST5 to determine whether the robot 1 interferes with peripheral equipment and the like. In step ST5, when it is determined that the robot 1 interferes with the peripheral device and the like (YES), the process proceeds to step ST9, and it is determined whether the number of times of determinations of YES is equal to or more than a designated number of times M.

In step ST9, the number of times of determinations of YES in step ST5 is counted, and when it is determined that the number of times of determinations of YES is equal to or more than the designated number of times M (YES), the holding position is calculated again by returning to step ST2. In other words, when the robot 1 interferes with the peripheral device and the like equal to or more that the designated number of times M in the pre-holding route calculated by step ST4, it is determined that the holding position calculated in step ST2 is not appropriate, and the holding position is re-calculated. It should be noted that, in step ST9, when it is determined that the determination of YES is not more than the designated number of times M (NO), the process returns to step ST4, and the pre-holding route is calculated again.

On the other hand, in step ST5, when it is determined that the robot 1 does not interfere with the peripheral device and the like (NO), the process proceeds to step ST6, and calculates (generates) a post-gripping route based on a hand shape (post-gripping hand shape) after gripping a workpiece W.

In other words, in step ST6, the post-gripping route from the take-out position of the workpiece W to a predetermined second position is generated based on the hand shape (post-gripping hand shape) after gripping the workpiece W. Specifically, the operation route generation unit 23 generates the post-gripping route based on the output of the take-out position calculation unit 22 and the spatial information storage unit 26, the post-gripping hand shape from the shape storage unit 27, and the image information from the image capturing device 3.

Further, in step ST7, it is determined whether the robot 1 interferes with peripheral equipment and the like. In step ST7, when it is determined that the robot 1 interferes with the peripheral equipment and the like (YES), the process proceeds to step ST10, and it is determined whether or not the determination of the YES is equal to or more than the designated number of times N.

In step ST10, the number of times of determination of YES in step ST7 is counted, and when it is determined that the number of times of determination of YES is equal to or more than a designated number of times N (YES), the holding position is calculated again by returning to step ST2. In other words, when the robot 1 interferes with the peripheral device and the like in the post-gripping route calculated in step ST6, the gripping position calculated in step ST2 is not appropriate, and the gripping position is re-calculated. In step ST10, when it is determined that the determination of YES is not less than the designated number of times N (NO), the process returns to step ST6, and the post-holding route is calculated again.

On the other hand, in step ST7, when it is determined that the robot 1 does not interfere with the peripheral device and the like (NO), the process proceeds to step ST8 to take out the workpiece W by the robot 1 (hand 11). In other words, simulation of the workpiece W taken out by the robot 1 (operation route) is completed, and the robot controller 2 actually controls the robot 1 to take out the workpiece W.

In this case, the designated number of times M in step ST9 and the designated number of times N in step ST10 are generally preferably set to M<N. This is because the determination of the YES (where the robot 1 interferes with the peripheral device and the like) in step ST7 is based on the determination of NO in step ST5 (the robot 1 does not interfere with peripheral equipment, and the like). Further, it is necessary to determine NO in step ST5 that the number of determination of YES in at least step ST5 is less than M.

Specifically, even if the number of times of processing (N) in step ST10 is more than the number of times (M) of processing in Step ST9, it is considered that the time may be reasonably utilized more reasonably than when returning to step ST2 and performing processing again. For example, when the process advanced to step ST7 is returned to step ST2 and processed again, it is considered that it is preferable to set M<N due to waste of equivalent time. It should be noted that the values of these M and N may be set to an optimum value in accordance with a robot system in which the robot control program of the present embodiment is actually applied.

As described above, according to the robot control program according to the present embodiment, it is possible to generate an efficient operation route without causing contact and the like through the hand 11 before and after gripping the workpiece W. The robot control program (program for simulating the operation route) described above may be executed by, for example, a computer added to the outside when the arithmetic processing capability of the robot controller 2 is insufficient.

The robot control program according to the present embodiment described above may be recorded in a computer-readable non-temporary recording medium or non-volatile semiconductor storage device and provided, or may be provided via wired or wireless communication. In this case, as a computer-readable non-temporary recording medium, for example, an optical disk such as a CD-ROM (Compact Disc Read Only Memory) or a DVD-ROM, or a hard disk device, and the like may be considered. Further, a PROM (Programmable Read Only Memory), a Flash Memory (registered trademark), and the like are conceivable as nonvolatile semiconductor memory devices. In addition, the distribution from the server device may be provided via a wired or wireless WAN (Wide Area Network), LAN (Local Area Network), or via the Internet.

As described in detail above, according to the robot controller, the robot system, and the robot control program according to the present embodiment, it is possible to generate an efficient operation route without causing contact and the like through the hand before and after gripping the object by the hand.

Although the embodiments of the present disclosure have been described in detail, the present disclosure is not limited to the individual embodiments described above. These embodiments include various additions and replacements without departing from the gist of the invention, or without departing from the idea and spirit of the invention derived from the content described in the claims and equivalents thereof, modification, partial deletion, and the like are possible. For example, in the above-described embodiments, the order of each operation and the order of each process are shown as an example, and are not limited to these. The same applies when numerical values or equations are used in the description of the above-described embodiments.

Regarding the above-described embodiments and variations, the following are further disclosed.

### Appendix 1

A robot controller (2) for controlling a robot (1) to take out a bulk-loaded object (W) by the robot (1) including a hand (11), comprising:
a take-out position calculation unit (22) configured to calculate a take-out position of an object (W) to be captured by the robot (1) based on image information from an image capturing device (3) that captures an image including the object (W);
a spatial information storage unit (26) configured to store a movable range in which the robot (1) is movable and an interference range in which the robot (1) interferes with surroundings in the movable range;
a shape storage unit (27) configured to store a shape of the robot (1) and the hand (11); and
an operation route generation unit (23) configured to generate an operation route of the hand (11) so as not to interface the robot (1) with the surroundings, based on outputs of the take-out position calculation unit (22), the spatial information storage unit (26) and the shape storage unit (27), wherein
the shape storage unit (27) is configured to store a pre-gripping hand shape before the hand (11) grips the object (W), and a post-gripping hand shape after the hand (11) grips the object (W).

### Appendix 2

The robot controller according to appendix 1, wherein
the image capturing device (3) is configured to capture an image including the object (W) and the hand (11).

### Appendix 3

The robot controller according to appendix 1 or 2, wherein
the image capturing device (3) is configured to capture an image of a three-dimensional image including the object (W) and the hand (11),
the operation route generation unit (23) is configured to generate the operation route of the hand (11) based on an output of the take-out position calculation unit (22), information of the three-dimensional image captured by the image capturing device (3), and the pre-gripping hand shape and the post-gripping hand shape stored in the shape storage unit (27).

### Appendix 4

The robot controller according to any one of appendixes 1 to 3, wherein
the operation route generation unit (23) is configured to
   generate a pre-gripping route from a predetermined first position to the take-out position of the object (W) based on the pre-gripping hand shape, and
   generate a post-gripping route from the take-out position of the object (W) to a predetermined second position based on the post-gripping hand shape.

### Appendix 5

The robot controller according to any one of appendixes 1 to 4, wherein
the shape storage unit (27) is configured to store a pre-gripping hand shape and a post-gripping hand shape corresponding to one type of objects (W) with a same shape.

### Appendix 6

The robot controller according to any one of appendixes 1 to 4, wherein
the shape storage unit (27) is configured to store shapes of a plurality types of objects (W1, W2, W3) with different shapes, and a plurality of pre-gripping hand shapes and a plurality of post-gripping hand shapes corresponding to the plurality types of objects (W1, W2, W3).

### Appendix 7

The robot controller according to appendix 6, wherein
the take-out position calculation unit (22) is configured to specify a type of the object (W) from among the plurality of objects (W1, W2, W3) stored in the shape storage unit (27) based on the image captured by the image capturing device (3), and is configured to calculate take-out positions (W1a, W2a, W3a) of the specified type of the object (W),
the shape storage unit (27) is configured to output a pre-gripping hand shape and a post-gripping hand shape corresponding to the specified type of the object (W), and
the operation route generation unit (23) is configured to generate an operation route of the hand (11) based on the output pre-gripping hand shape and the output post-gripping hand shape.

### Appendix 8

The robot controller according to any one of appendixes 1 to 7, wherein
the hand (11) is attached to a movable portion operable with respect to the robot (1),
the operation route generation unit (23) is configured to correct the pre-gripping hand shape and the post-gripping hand shape stored in the shape storage unit (27) based on an operation of the hand (11) with respect to the robot (1) by the movable portion, and is configured to generate an operation route of the hand (11).

### Appendix 9

The robot controller according to any one of appendixes 1 to 8, further comprising:
an object shape measurement unit (28) configured to measure an object shape of the object (W) based on the image information from the image capturing device (3); and
a post-gripping hand shape generation unit (29) configured to generate the post-gripping hand shape based on the object shape measured by the object shape measurement unit, wherein
the operation route generation unit (23) is configured to generate an operation route of the hand (11) so that the robot (1) does not interfere with surroundings based on an output of the post-gripping hand shape generation unit (29).

### Appendix 10

The robot controller according to any one of appendixes 1 to 9, wherein
the object (W) is a plurality of objects (W) randomly placed inside a housing vessel,
the hand (11) sequentially takes out individual objects (W) in the housing vessel, and
the housing vessel is replaced with another housing vessel in order.

### Appendix 11

The robot controller according to appendix 10, wherein
the operation route generation unit (23) is configured to grip changes in the shape and arrangement position of the housing vessel based on the image information from the image capturing device (3), and is configured to generate an operation route of the hand (11).

### Appendix 12

A robot system (100) including a robot (1) having a hand (11) configured to take out a bulk-loaded object (W), an image capturing device (3) configured to capture an image including the object (W), and a robot controller (2) configured to control the robot (1) so as to take out the object (W) by the hand (11), wherein
the robot controller (2) is a robot controller according to any one of appendixes 1 to 11.

### Appendix 13

A robot control program for a robot system (100) including a robot (1) having a hand (11) configured to take out a bulk-loaded object (W), an image capturing device (3) configured to capture an image including the object (W), and a robot controller (2) configured to control the robot (1) so as to take out the object (W) by the hand (11), the robot control program causing an arithmetic processing unit (21) to execute:
a process of calculating a take-out position of an object (W) to be captured by the robot (1) based on the image information from the image capturing device (3); and
a process of generating an operation route of the hand (11) so as not to interface the robot (1) with surroundings, based on the image information from the image capturing device (3), an output of a spatial information storage unit (26) configured to store an interference range in which the robot (1) interferes with surroundings in a movable range, and an output of a shape storage unit (27) configured to store a shape of the robot (1) and the hand (11), wherein
the shape storage unit (27) is configured to store a pre-gripping hand shape before the hand (11) grips the object (W), and a post-gripping hand shape after the hand (11) grips the object (W).

### Appendix 14

The robot control program according to appendix 13, wherein
the process of generating the operation route of the hand (11) includes:
   a pre-gripping route generation process configured to generate a pre-gripping route from a predetermined first position to a take-out position of the object (W) based on the pre-gripping hand shape; and
   a post-gripping route generation process configured to generate a post-gripping route from the take-out position of the object (W) to a predetermined second position based on the post-gripping hand shape is included.

### Reference Signs List

1 Robot
2 Robot Controller
3 Image Capturing Device
4 Container (Housing Vessel)
10 Arm
11 Hand
11a, 11b Hand Pawl
11c Hand (Adsorption Type)
21 Processing Unit (Arithmetic Processing Unit)
22 Take-Out Position Calculation Unit
23 Operation Route Generating Unit
24 Storage Unit
25 Route Generation Program
26 Space Information Storage Unit
27 Shape Storage Unit
28 Workpiece Shape Measurement Unit (Object Shape Measurement Unit)
29 Post-Gripping Hand Shape Generation Unit
100 Robot System
W Workpiece (Object)

1. A robot controller for controlling a robot to take out a bulk-loaded object by the robot including a hand, comprising:
a take-out position calculation unit configured to calculate a take-out position of an object to be captured by the robot based on image information from an image capturing device that captures an image including the object;
a spatial information storage unit configured to store a movable range in which the robot is movable and an interference range in which the robot interferes with surroundings in the movable range;
a shape storage unit configured to store a shape of the robot and the hand; and
an operation route generation unit configured to generate an operation route of the hand so as not to interface the robot with the surroundings, based on outputs of the take-out position calculation unit, the spatial information storage unit and the shape storage unit, wherein
the shape storage unit is configured to store a pre-gripping hand shape before the hand grips the object, and a post-gripping hand shape after the hand grips the object.

2. The robot controller according to claim 1, wherein
the image capturing device is configured to capture an image including the object and the hand.

3. The robot controller according to claim 1, wherein
the image capturing device is configured to capture an image of a three-dimensional image including the object and the hand,
the operation route generation unit is configured to generate the operation route of the hand based on an output of the take-out position calculation unit, information of the three-dimensional image captured by the image capturing device, and the pre-gripping hand shape and the post-gripping hand shape stored in the shape storage unit.

4. The robot controller according to claim 1, wherein
the operation route generation unit is configured to
generate a pre-gripping route from a predetermined first position to the take-out position of the object based on the pre-gripping hand shape, and
generate a post-gripping route from the take-out position of the object to a predetermined second position based on the post-gripping hand shape.

5. The robot controller according to claim 1, wherein
the shape storage unit is configured to store a pre-gripping hand shape and a post-gripping hand shape corresponding to one type of objects with a same shape.

6. The robot controller according to claim 1, wherein
the shape storage unit is configured to store shapes of a plurality types of objects with different shapes, and a plurality of pre-gripping hand shapes and a plurality of post-gripping hand shapes corresponding to the plurality types of objects.

7. The robot controller according to claim 6, wherein
the take-out position calculation unit is configured to specify a type of the object from among the plurality of objects stored in the shape storage unit based on the image captured by the image capturing device, and is configured to calculate take-out positions of the specified type of the object,
the shape storage unit is configured to output a pre-gripping hand shape and a post-gripping hand shape corresponding to the specified type of the object, and
the operation route generation unit is configured to generate an operation route of the hand based on the output pre-gripping hand shape and the output post-gripping hand shape.

8. The robot controller according to claim 1, wherein
the hand is attached to a movable portion operable with respect to the robot,
the operation route generation unit is configured to correct the pre-gripping hand shape and the post-gripping hand shape stored in the shape storage unit based on an operation of the hand with respect to the robot by the movable portion, and is configured to generate an operation route of the hand.

9. The robot controller according to claim 1, further comprising:
an object shape measurement unit configured to measure an object shape of the object based on the image information from the image capturing device; and
a post-gripping hand shape generation unit configured to generate the post-gripping hand shape based on the object shape measured by the object shape measurement unit, wherein
the operation route generation unit is configured to generate an operation route of the hand so that the robot does not interfere with surroundings based on an output of the post-gripping hand shape generation unit.

10. The robot controller according to claim 1, wherein
the object is a plurality of objects randomly placed inside a housing vessel,
the hand sequentially takes out individual objects in the housing vessel, and
the housing vessel is replaced with another housing vessel in order.

11. The robot controller according to claim 10, wherein
the operation route generation unit is configured to grip changes in the shape and arrangement position of the housing vessel based on the image information from the image capturing device, and is configured to generate an operation route of the hand.

12. A robot system including a robot having a hand configured to take out a bulk-loaded object, an image capturing device configured to capture an image including the object, and a robot controller configured to control the robot so as to take out the object by the hand, wherein
the robot controller is a robot controller according to claim 1.

13. A computer readable non-transitory tangible medium for storing a robot control program for a robot system including a robot having a hand configured to take out a bulk-loaded object, an image capturing device configured to capture an image including the object, and a robot controller configured to control the robot so as to take out the object by the hand, the robot control program causing an arithmetic processing unit to execute:
a process of calculating a take-out position of an object to be captured by the robot based on the image information from the image capturing device; and
a process of generating an operation route of the hand so as not to interface the robot with surroundings, based on the image information from the image capturing device, an output of a spatial information storage unit configured to store an interference range in which the robot interferes with surroundings in a movable range, and an output of a shape storage unit configured to store a shape of the robot and the hand, wherein
the shape storage unit is configured to store a pre-gripping hand shape before the hand grips the object, and a post-gripping hand shape after the hand grips the object.

14. The computer readable non-transitory tangible medium for storing the robot control program according to claim 13, wherein
the process of generating the operation route of the hand includes:
a pre-gripping route generation process configured to generate a pre-gripping route from a predetermined first position to a take-out position of the object based on the pre-gripping hand shape; and
a post-gripping route generation process configured to generate a post-gripping route from the take-out position of the object to a predetermined second position based on the post-gripping hand shape is included.
